(19) United States
(12) Patent Application Publication
(10) Pub. No.: US 2007/0081363 A1
(43) Pub. Date: Apr. 12, 2007

(54) Holiday light assembly with hanging light clusters

(75) Inventor: Ralph Scott Heese, Omaha, NE (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Holiday Bright Lights LLC, Omaha, NE (US)

(21) Appl. No.: 11/207,662

(22) Filed: Aug. 18, 2005

(51) Int. Cl. H01R 33/00

(52) U.S. Cl. 362/654

(57) ABSTRACT

A holiday light assembly has a main support rod and a plurality of hanging support structures each having a hanging branch rod supported from the main support rod, and holiday lights supported on the hanging support structures to form desired lighting patterns. The hanging branch rods of the hanging support structures are connected to the main support rod with swivel joints to allow them to be placed conveniently at a desired hanging angle when the light assembly is installed on a sloped structure, such as the gable of a house. The swivel joints may be of a ratcheting type and may be spring loaded to allow quick angular adjustments.

### FIELD OF THE INVENTION

This invention relates to strings of holiday lights such as those used for Christmas decorations, and more particularly to a holiday light assembly that has light clusters that can be positioned at an adjustable hanging angle.

### BACKGROUND OF THE INVENTION

Lights are widely used for decorations for holidays such as Christmas to enhance the festival atmosphere. Holiday lights generally are in the form of a plurality of miniature lights connected by wires into a string. The string of holiday lights can be wrapped around or otherwise supported on different structures, such as trees or exterior parts of a house, to provide the lighting effects. Over the years, the presentations of holiday lights have become quite sophisticated, and various types of holiday light arrangements and assemblies are available for different locations and applications.

For instance, in decorating the exterior of a house with holiday lights, it is often difficult to hang a loose array of holiday lights neatly along a sloped structure, such as the gable of the house. To make it easier to install holiday lights on an angled structure, a holiday light assembly has been provided that has a main support rod and a plurality of light clusters supported on branch rods that are welded onto the main support rod. The main support rod has mounting features such as rings at its ends to allow it to be secured by nails or other means to a mounting surface. Once the light assembly is secured to the mounting surface of an angled structure such as the gable of a house, the installer has to manually bend the branch rod of each light cluster to achieve a desired hanging angle for the respective light cluster. Although this arrangement provides good support for the holiday lights, the need to bend the branch rods of the light clusters by hand makes the installation of the light assembly inconvenient and time consuming, especially when the installer is standing on a ladder in order to reach the height of the mounting surface. Also, bending the branch rods may compromise the integrity of the protective paint coat at the welded joints between the branch rods and the main support rod, allowing rust to form over time. Repeated bending of the branch rods may also cause the welded joints to break.

### SUMMARY OF THE INVENTION

In view of the foregoing, it is an object of the invention to provide a holiday light assembly with hanging light clusters that can easily be installed on an angled structure, such as the gable of a house, and can easily be adjusted to achieve desired hanging angles of the light clusters.

It is a related object of the invention to provide a way to mount light clusters in the holiday light assembly that allows easy adjustment of the hanging positions of the light clusters and enables the user to maintain the hanging positions of the light clusters after the adjustment.

These objects are achieved by the holiday light assembly of the invention. The holiday light assembly has a support structure that includes a main support rod and a plurality of hanging support structures, onto each of which a cluster of holiday lights are arranged into a desired lighting pattern. Each hanging support structure comprises a hanging branch rod connected to the main support rod by a swivel joint, such that the hanging branch rod can easily be set at a desired hanging angle with respect to the main support rod. The swivel joint may include a ratchet mechanism that allows that hanging branch rod to assume one of multiple pre-set angular positions with respect to the main support rod. Light covers with integrally formed clips may be used for mounting holiday lights on the main support rod and the hanging support structures of the light assembly.

The invention will be explained in more detail in the following description with reference to the associated drawings, in which:

### BRIEF DESCRIPTION OF THE DRAWINGS

FIG. 1 shows in a perspective view an embodiment of a holiday light assembly constructed in accordance with the invention;

FIG. 2 shows the holiday light assembly of FIG. 1 mounted on a sloped mounting surface and with its light clusters set at desired hanging positions;

FIG. 3 shows a top view of a swivel joint with a ratchet mechanism that connects a hanging branch rod of a light cluster to the main support rod of the light assembly;

FIG. 4 is an exploded view of the ratchet mechanism of the swivel joint shown in FIG. 3;

FIG. 5 is a top view of an alternative construction of a swivel joint with a ratchet mechanism;

FIG. 6 is a top view of an alternative construction of a swivel joint;

FIG. 7 is a top view of another alternative construction of a swivel joint; and

FIG. 8 is a perspective view showing a light cover with an integrally formed clip for mounting holiday lights to the support structure of the light assembly.

### DETAILED DESCRIPTION OF EMBODIMENTS OF THE INVENTION

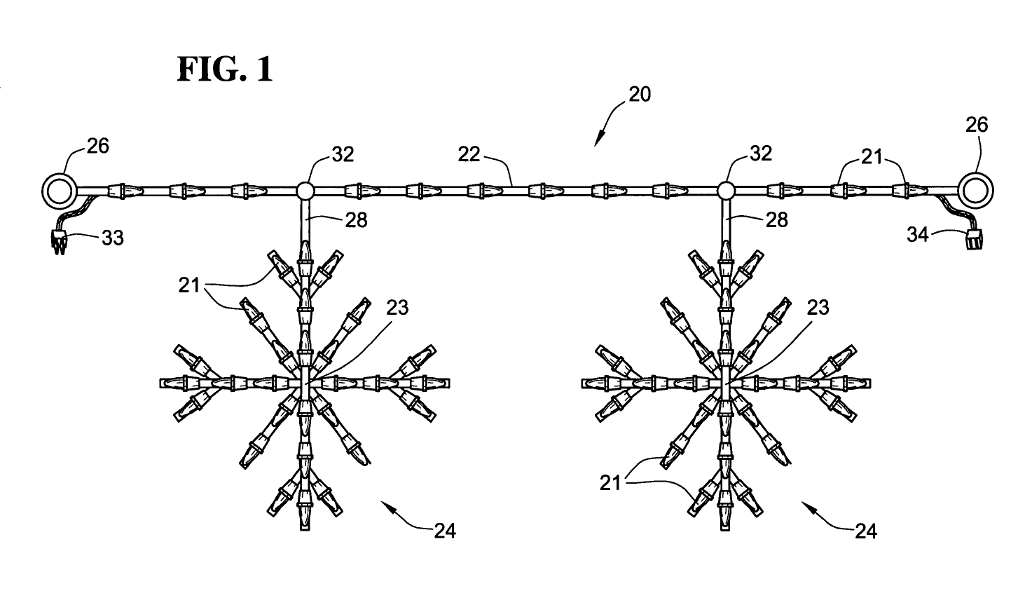

The present invention provides a holiday light assembly with hanging light clusters that is suitable for mounting on a sloped structure and allows the hanging angles of light clusters to be easily adjusted during installation. In one embodiment shown in FIG. 1, the holiday light assembly 20 has a support structure that includes a main support rod 22 and one or more hanging support structures 23 connected to the main support rod. Preferably the main support rod 22 and the hanging support structures 23 are made from a paintable or rust-proof rigid material (such as stainless steel) or a rigid plastic material. The main support rod 22 is provided with mounting means to allow the rod to be attached to a mounting surface, such as the surface of the gable of a house. In the illustrated embodiment, the mounting means includes rings 26 at the two ends of the main support rod 22, which may be secured to a mounting surface by nails. Other types of mounting means, such as hooks, may also be used.

Each hanging light cluster 24 in the light assembly 20 is supported on a hanging support structure 23 that includes a hanging branch rod 28 connected to the main support rod 22. The hanging support structures 23 may have different shapes and constructions depending on the desired lighting pattern of the holiday lights supported thereon. For example, in the embodiment shown in FIG. 1, the hanging support structure 23 is a star-shaped structure with sub-branches, such that it resembles the shape of a snow flake. Holiday lights 21 are then mounted on this structure to give a lighting pattern suggestive of a snow flake. It will be appreciated that many other types of lighting patterns can be achieved by suitable constructions of the hanging support structure and distribution of holiday lights on the hanging support structure. For instance, the hanging support structure may be a simple straight rod with holiday lights mounted thereon in an array such that it is suggestive of an icicle when the light assembly is mounted along the edge of the roof of a house. Moreover, light clusters of different lighting patterns may be combined in one light assembly. For instance, a light assembly may have snow-flake light clusters interleaved with icicle light clusters.

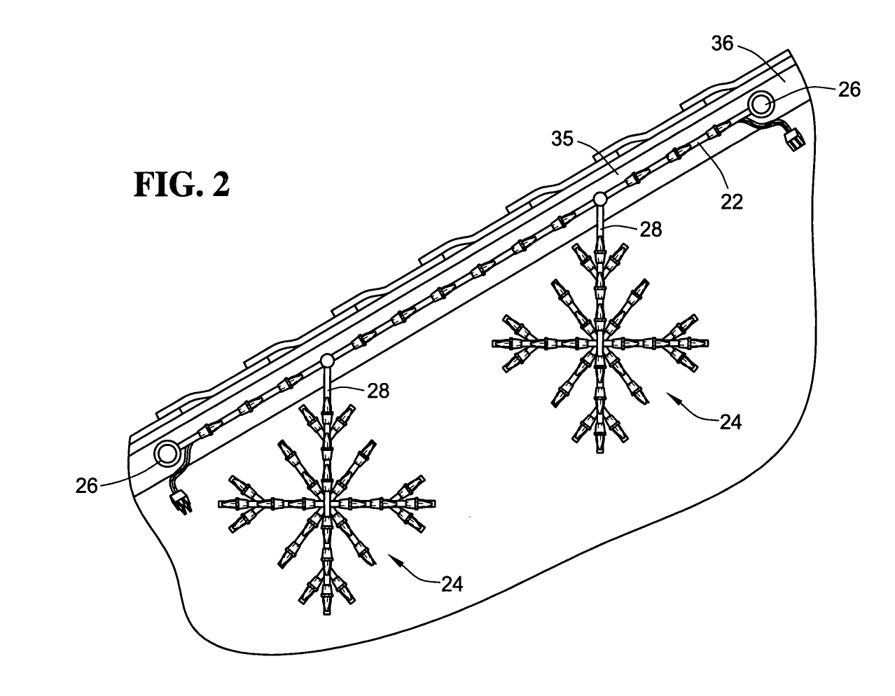

In accordance with a feature of the invention, the hanging branch rods 28 are connected to the main support rod 22 by means of swivel joints 32. A swivel joint 32 allows the light cluster 24 to be easily rotated during installation to assume a desired hanging angle when the light assembly is mounted on a sloped structure. By way of example, FIG. 2 illustrates the light assembly 20 mounted on the surface 35 of a gable 36 of a house. Depending on the length of the gable 36, multiple light assemblies may be mounted in a row along the gable and electrically connected via male and female connectors 33, 34 to cover the entire length of the gable. As shown in FIG. 2, the light clusters 24 hang from main support rod 22 such that they are substantially vertical to the ground and angled relative to the main support rod. It will be appreciated, however, that the light clusters 24 can assume other desired hanging positions that are not vertical or substantially vertical to the ground.

During installation of the light assembly 20, an installer first secures the entire light assembly to the mounting surface by, for example, nailing the end rings 26 of the main support rod 22 to the mounting surface 35 of the gable 36. The installer can then move each light cluster 24 to the desired hanging position by means of the swivel joint 32 connecting the hanging branch rod 28 to the main support rod 22. In this way, the hanging positions of the light clusters can be conveniently and quickly set without much effort.

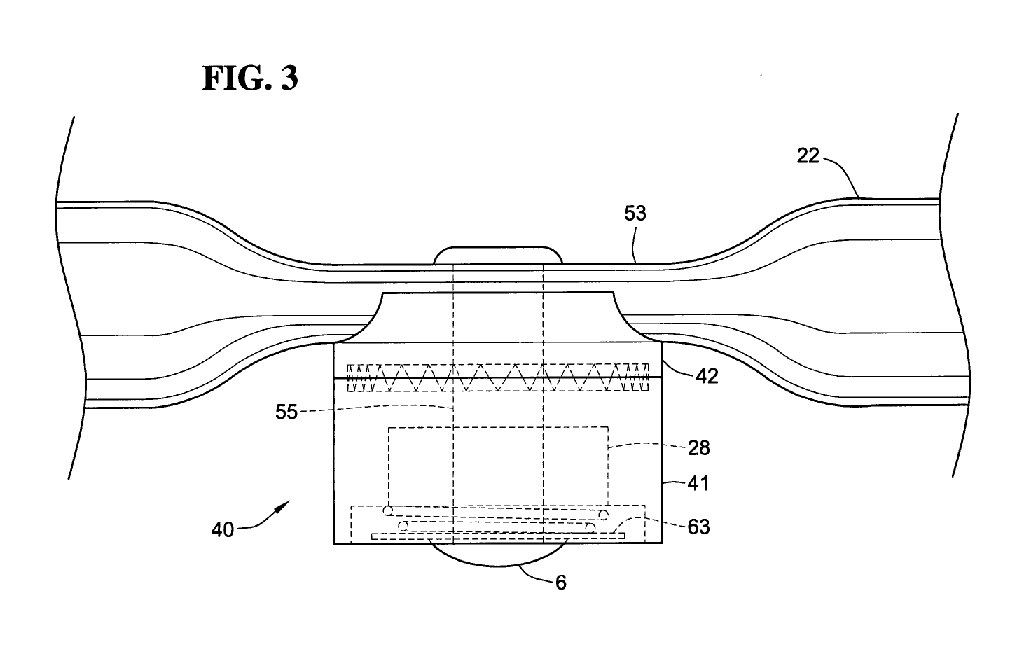

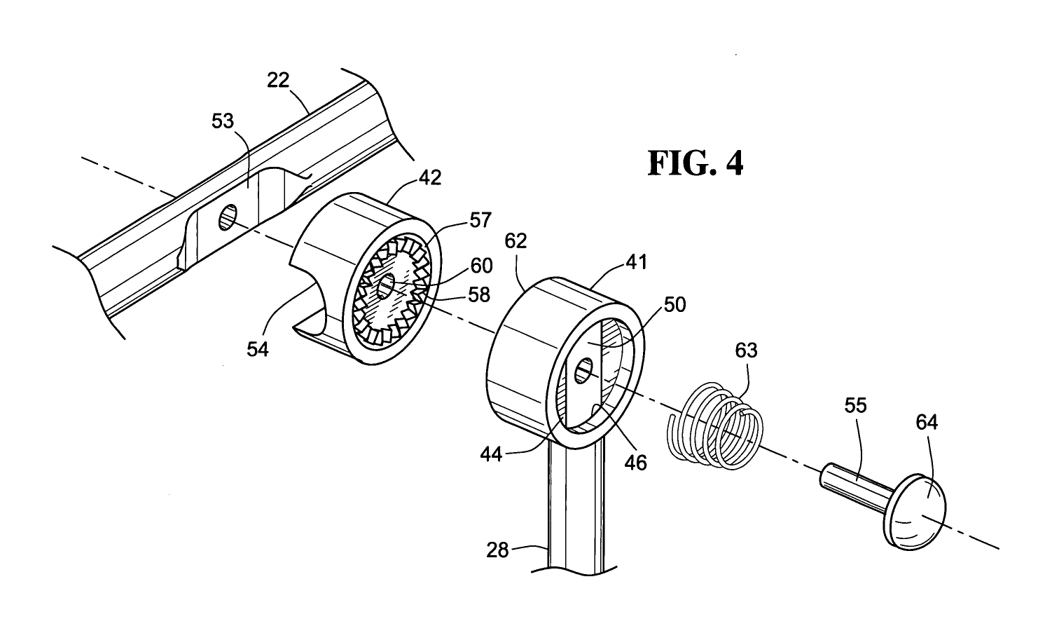

In one preferred embodiment, the swivel joint 32 connecting the hanging branch rod 28 of a light cluster 24 to the main support rod 22 comprises a ratchet mechanism that allows the hanging branch rod to be held at one of a plurality of pre-set angles with respect to the main support rod. As shown in FIGS. 3 and 4, the ratchet mechanism 40 includes two cooperating ratchet members 41, 42, which may be made of plastic or other suitable materials. The hanging branch rod 28 of the light cluster extends through and engages the first ratchet member 41, which has a coupling grove 44 and a side opening 46 formed therein to receive the flattened end 50 of the hanging branch rod 28. The coupling grove 44 prevents the flattened end 50 of the hanging branch rod 28 received therein from rotating in relation to the first ratchet member 41. The second ratchet member 42 engages a flattened section 53 of the main support rod 22 and has a coupling notch 54 formed in its rear surface to ride over the main support rod 22, thus preventing it from rotating with respect to the main support rod. The first ratchet member 41, the flattened end 50 of the hanging branch rod 28, and the second ratchet member 42 are fastened to the flattened section 53 of the main support rod 22 by a rivet 55.

As shown in FIG. 4, the second ratchet member 42 includes a contact surface 57 that has a plurality of teeth 58 extending radially from a central mounting hole 60. The first ratchet member 41 has a similarly constructed contact surface 62 with radial teeth facing the contact surface 57 of the second ratchet member 42. When the first and second ratchet members 41 and 42 are pressed together to engage each other, their respective radially extending teeth mesh together to resist rotation of the two ratchet members relative to one another, unless a sufficient rotational force is applied to move the teeth from their intermeshed engagement to allow repositioning of the first ratchet member 41 in relation to the second ratchet member 42.

To enable easy adjustment of the relative angular position of the hanging branch rod 28 and the main support rod 22 while providing a force to maintain an adjusted position, a spring 63 is used to provide axial loading of the ratchet mechanism. The spring 63 is positioned around the axis of the rivet 55 connecting the ratchet mechanism 40 to the main support rod 22, and is held in a compressed state between the rivet head 64 and a front surface of the first ratchet member 41. The axial biasing force applied by the spring 63 pushes the first ratchet member 41 towards the second ratchet member 42 to cause the teeth of their respective contact surfaces to mesh, thereby providing a resistance to the relative rotation between the ratchet members. This resistance to rotation allows the hanging branch rod 28 to be held in a desired position with respect to the main support rod 22 once it is set, thereby preventing the hanging angle of the light cluster from being changed by wind or accidental touching of the cluster. This resistance to rotation, however, is of a magnitude such that it can be relatively easily overcome when a user rotates the hanging branch rod 28 relative to the main support rod 22 by hand, to allow the light cluster to be easily set at a desired hanging position during installation of the light assembly.

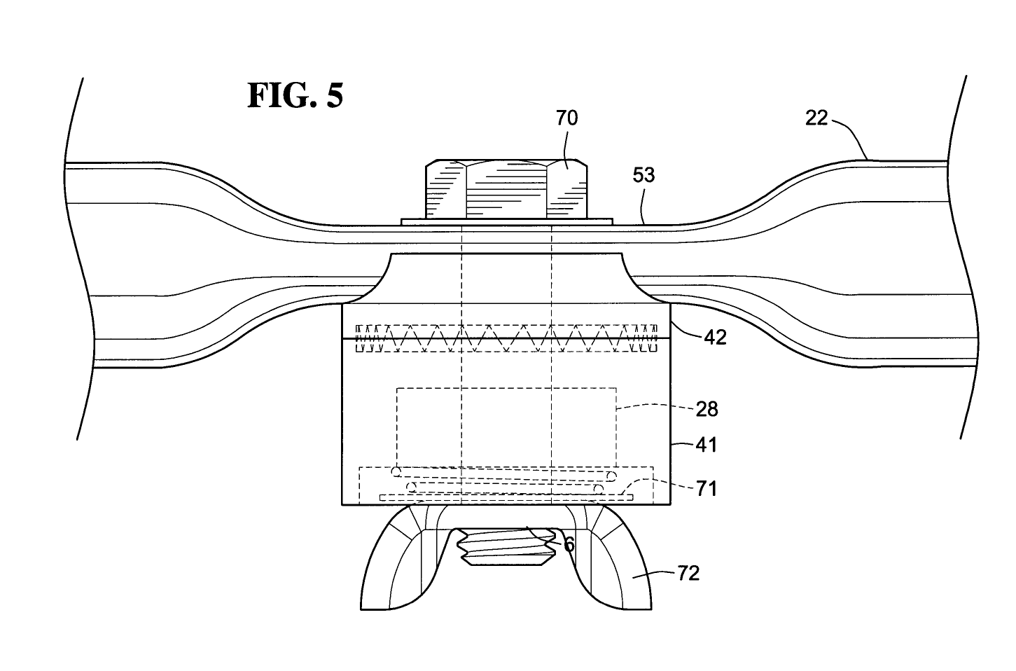

The swivel joint connecting the hanging branch rod of a light cluster to the main support rod may be constructed in different ways. For instance, instead of using a rivet and spring loading as in the embodiment shown in FIGS. 3 and 4, in an alternative embodiment shown in FIG. 5 the hanging branch rod 28 and the ratchet members 41, 42 are connected to the main support rod 22 by a bolt 70 and a nut 72 (preferably a wing nut to facilitate tightening by hand). The ratchet mechanism may optionally include a biasing spring 71 disposed between the nut 72 and the first ratchet member 41, 42, and the biasing force exerted by the spring 71 on the first ratchet member 41 can be adjusted by tightening or loosening the nut 72.

Alternatively, the spring 71 can be omitted, and the nut 72 can be tightened to firmly press the first ratchet member 41 towards the second ratchet member 42, or be loosened slightly to allow the hanging branch rod 28 to rotate about the bolt 70. After the light assembly 20 is secured to a mounting surface and the light cluster 24 is moved to a desired hanging position, the installer can tighten the nut 72 to press the ratchet members 41, 42 together to prevent disengagement of their intermeshing teeth, thereby maintaining the hanging branch rod 28 at the desired hanging angle.

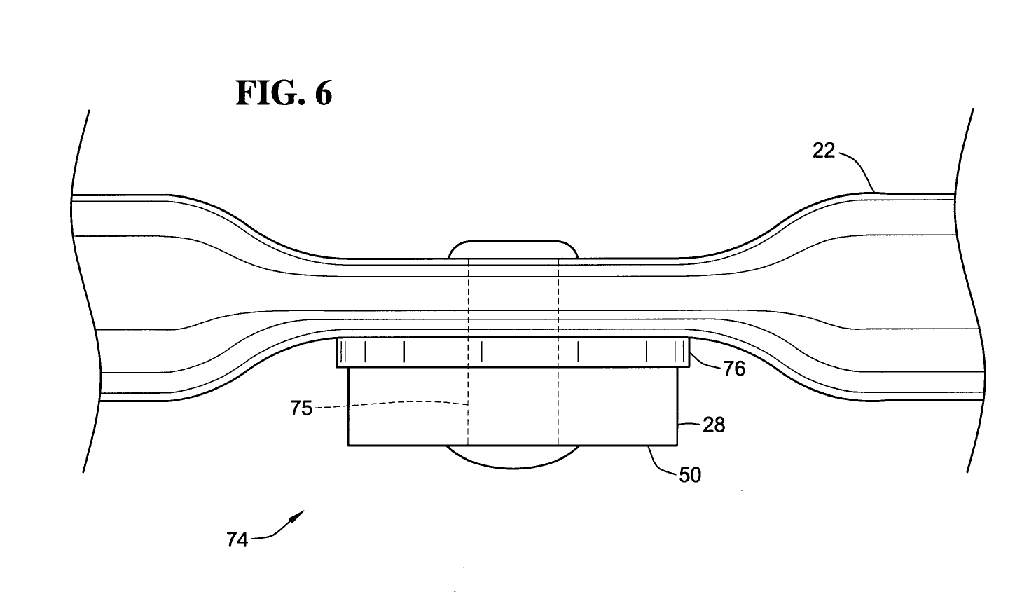

As yet another example, an alternative construction of a swivel joint 74 is shown in FIG. 6. In this relatively simple construction, the flattened end 50 of the hanging branch rod 28 is secured to the main support rod 22 by a rivet 75. A gasket 76 may optionally be inserted between the flattened end 50 of the hanging branch rod 28 and the main support rod 22 to allow the hanging branch rod to rotate more readily about the rivet 75. The gasket 76 may be made of a suitable material, such as Teflon, and may be slightly compressed by the rivet 75 axially to provide some resistance to relative rotation between the hanging branch rod 28 and main support rod 22 while still allowing the rotation to be made with relative ease.

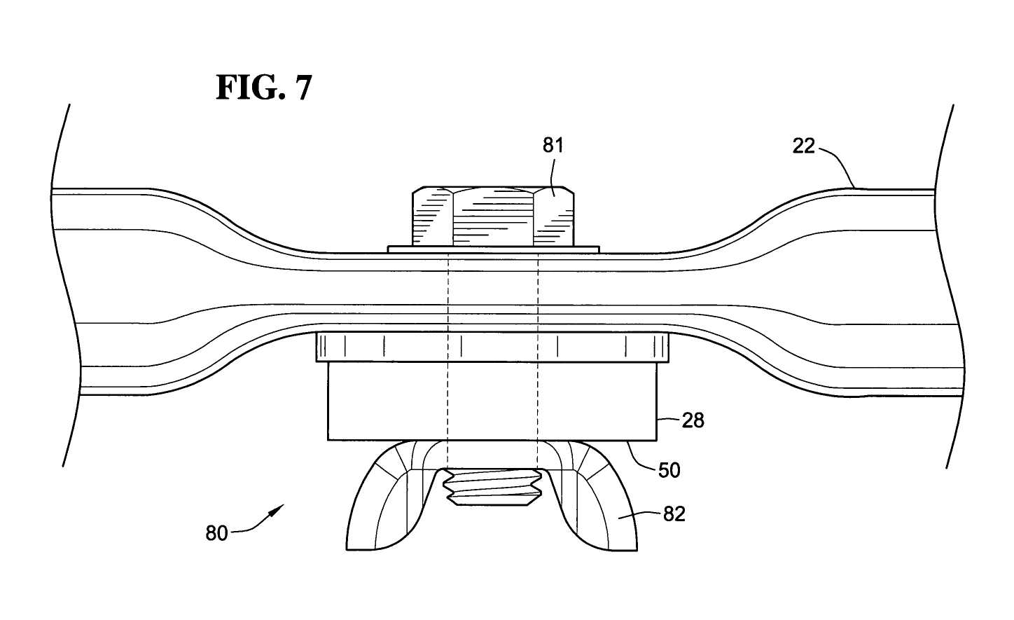

FIG. 7 shows another alternative construction of a swivel joint 80 for connecting the hanging branch rod 28 to the main support rod 22. This swivel joint 80 is similar to that shown in FIG. 6, but with the rivet 75 replaced by a bolt 81 and a nut 82 (preferably a wing nut). Thus, after the light cluster is set at a desired hanging position, the installer can tighten the nut 82 to secure the angle between the hanging branch rod 28 and the main support rod 22.

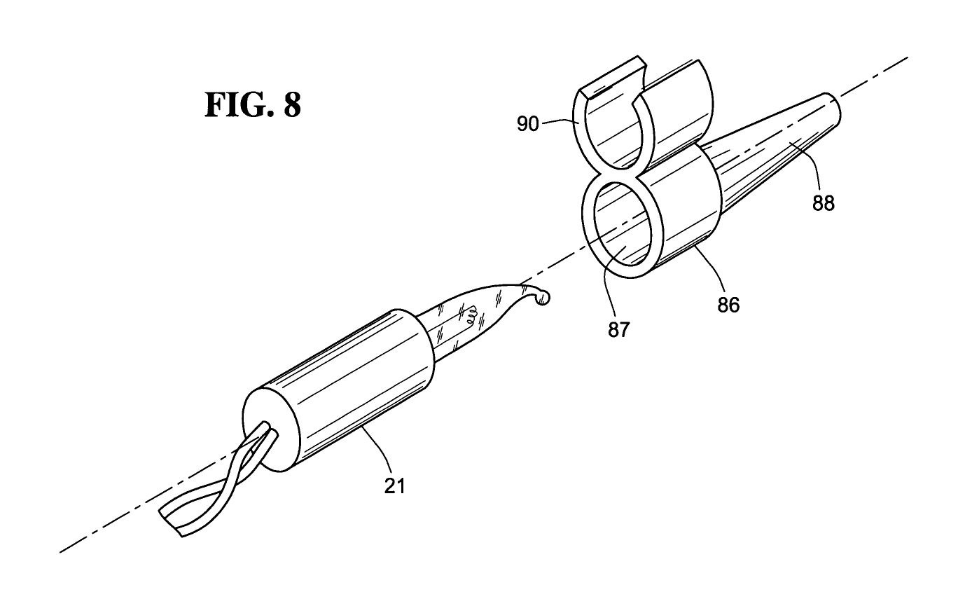

In one embodiment, the holiday lights 21 in the light assembly are mounted on the main support rod 22 and the hanging support structures 23 by means of light covers that have integrally formed clips. As shown in FIG. 8, each light cover 86 has an open end 87 for receiving a holiday light 21, and a closed end 88 that has light-diffraction structures formed therein for shaping (and if desired, coloring) the light generated by the holiday light 21. The light cover may be made of, for example, a plastic material that is clear or of a desired color. A clip 90 integrally formed on the light cover 86 can be snapped onto the main support rod 22 or a rod in the hanging support structure 23 of the light cluster 24 for securing the light cover 86 and the holiday light 21 inserted therein onto the rod. The holiday lights 21 in the light assembly are further mounted by wrapping their connecting wires around the main support rod 22 and the hanging support structures 23.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiments can be modified in arrangement and detail without departing from the spirit of the invention. Therefore, the invention as described herein contemplates all such embodiments as may come within the scope of the following claims and equivalents thereof.

1. A holiday light assembly comprising:
a support structure having a main support rod and one or more hanging support structures, each of the hanging support structures having a hanging branch rod connected to the main support rod by a swivel joint to allow the hanging branch rod to be positioned at a desired hanging angle from the main support rod; and
a plurality of holiday lights supported on at least each of the hanging support structures to form a desired lighting pattern.

2. A holiday light assembly as in claim 1, wherein the swivel joint includes a ratchet mechanism for holding the hanging branch rod at one of a plurality of pre-set angular positions with respect to the main support rod.

3. A holiday light assembly as in claim 2, wherein the ratchet mechanism includes a first ratchet member coupled to the hanging branch rod and a second ratchet member coupled to the main support rod, the first and second ratchet members having opposing contact surfaces each with matching teeth that intermesh when the first and second ratchet members are engaged.

4. A holiday light assembly as in claim 3, wherein the ratchet mechanism further includes a spring for biasing the first ratchet member towards the second ratchet member.

5. A holiday light assembly as in claim 2, wherein the hanging branch rod and the ratchet mechanism are connected to the main support rod with a bolt and a nut.

6. A holiday light assembly as in claim 1, wherein the swivel joint includes a rivet connecting an end of the hanging branch rod to the main support rod.

7. A holiday light assembly as in claim 1, wherein the swivel joint includes a bolt and a wing nut connecting an end of the hanging branch rod to the main support rod.

8. A holiday light assembly as in claim 1, further including a plurality of light covers mounted on the support structure, each light cover having an open end for receiving a holiday light and an integrally formed clip for holding onto the support structure.

9. A holiday light assembly as in claim 8, wherein the light cover has a closed end formed with light diffraction structures for shaping light generated by the holiday light received in the light cover.

10. A support structure for a holiday light assembly, comprising:
a main support rod;
one or more hanging support structures, each of the hanging support structures having a hanging branch rod connected to the main support rod by a swivel joint to allow the hanging branch rod to be positioned at a desired hanging angle from the main support rod; and
a plurality of light covers mounted onto the plurality of hanging support structures, each light cover having an open end for receiving a holiday light and an integrally formed mounting clip.

11. A support structure for a holiday light assembly as in claim 10, wherein the swivel joint includes a ratchet mechanism for holding the hanging branch rod at one of a plurality of pre-set angular positions with respect to the main support rod.

12. A support structure for a holiday light assembly as in claim 11, wherein the ratchet mechanism includes a first ratchet member coupled to the hanging branch rod and a second ratchet member coupled to the main support rod, the first and second ratchet members having opposing contact surfaces each with matching teeth that intermesh when the first and second ratchet members are engaged.

13. A support structure for a holiday light assembly as in claim 12, wherein the ratchet mechanism further includes a spring for biasing the first ratchet member towards the second ratchet member.

14. A support structure for a holiday light assembly as in claim 11, wherein the hanging branch rod and the ratchet mechanism are connected to the main support rod with a bolt and a nut.

15. A support structure for a holiday light assembly as in claim 10, wherein the swivel joint includes a rivet connecting an end of the hanging branch rod to the main support rod.

16. A support structure for a holiday light assembly as in claim 10, wherein the swivel joint includes a bolt and a nut connecting an end of the hanging branch rod to the main support rod.

17. A support structure for a holiday light assembly as in claim 10, wherein each light cover has a closed end formed with light diffraction structures for shaping light generated by a holiday light received in the light cover.
